(19) United States
(12) Patent Application Publication
(10) Pub. No.: US 2007/0291694 A1
(43) Pub. Date: Dec. 20, 2007

(54) Seamless Multimedia Session Handoff Across Multiple Devices in a Mobile Networking Environment

(76) Inventor: Junbiao Zhang, Bridgewater, NJ (US)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 11/660,837

(22) PCT Filed: Sep. 3, 2004
(86) PCT No.: PCT/US04/28953

§ 371 Date: Feb. 22, 2007

(51) Int. Cl. H04L 12/20

(52) U.S. Cl. 370/331; 370/351

(57) ABSTRACT

There is provided, in a source device, a method for handing off a media session from the source device to a target device in a network. The target device is informed of an impending handoff of the media session. Session state information is transmitted to the target device in preparation for the handoff. The source device is authenticated with respect to a router that is common to both the source device and the target device, prior to the handoff. The conducting of the media session on the source device is ceased in place of the target device, subsequent to the handoff.

### BACKGROUND OF THE INVENTION

1. Field of the Invention

The present invention generally relates to networks and, more particularly, to a method and system for handing off a media session across multiple devices in a network environment.

2. Background of the Invention

In some circumstances, it would be advantageous for a user to be able to conduct a multimedia session over multiple devices (mobile or fixed). For example, such a capability is particularly useful in a mobile environment where a user can move around while still maintaining multimedia session continuity. Unfortunately, existing solutions only address the problem of maintaining session continuity on a single mobile device across different networks.

Accordingly, it would be desirable and highly advantageous to have a method and system for handing off a media session across multiple devices in a network environment.

### SUMMARY OF THE INVENTION

The problems stated above, as well as other related problems of the prior art, are solved by the present invention, which is directed to a method and system for handing off a media session across multiple devices in a network environment.

According to an aspect of the present invention, there is provided a method for handing off a media session from a source device to a target device in a network. The target device is informed of an impending handoff of the media session. Session state information is transmitted to the target device in preparation for the handoff. The source device is authenticated, typically via a router that is common to both the source device and the target device, prior to the handoff. The conducting of the media session on the source device is ceased in place of the target device, subsequent to the handoff.

According to another aspect of the present invention, there is provided, a method for handing off a media session from a source device to the target device in a network. A communication is received of an impending handoff of the media session to the target device. Session state information is received from the source device in preparation for the handoff. The target device is authenticated, typically via a router that is common to both the source device and the target device. The media session is conducted thereon in place of the source device.

According to yet another aspect of the present invention, there is provided a method for handing off a media session from a source device to a target device in a network. The source device and the target device are authenticated with respect to an impending handoff from the source device to the target device. Session related information is obtained from at least one of the source device and the target device. The session is redirected from the source device to the target device.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 is a diagram illustrating an environment 100 in which the present invention can be employed, according to an illustrative embodiment of the present invention; and

FIG. 2 is a flow diagram illustrating a method for handing off a media session from a first device to a second device in a network environment, according to an illustrative embodiment of the present invention.

### DETAILED DESCRIPTION OF THE INVENTION

The present invention is directed to a method and system for handing off a media session across multiple devices in a network environment.

The present invention allows for seamlessly moving media sessions across multiple devices. Thus, for example, a current video session can be moved from a mobile user's Personal Digital Assistant (PDA) to single device (e.g., a nearby projector) or to multiple devices that are close to the user while the user moves around.

Advantageously, to successfully execute such a scheme, the present invention employs an intelligent network to redirect packet flows of the multimedia sessions to the intended devices. The devices across which the sessions are handed over coordinate with each other to transfer session states and seamlessly resume the display of the media stream.

It is to be appreciated that the present invention can be utilized for single media and multimedia applications. Moreover, it is to be appreciated that the present invention can be utilized with respect to mobile devices, fixed (stationary) devices, or any combination thereof. Further, it is to be appreciated that the present invention can be utilized with respect to wireless devices, wired devices, or any combination thereof.

It is to be understood that the present invention can be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program can be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein can either be part of the microinstruction code or part of the application program (or a combination thereof) that is executed via the operating system. In addition, various other peripheral devices can be connected to the computer platform such as an additional data storage device and a printing device.

It is to be further understood that, because some of the constituent system components and method steps depicted in the accompanying Figures are preferably implemented in software, the actual connections between the system components (or the process steps) can differ depending upon the manner in which the present invention is programmed. Given the teachings herein, one of ordinary skill in the related art will be able to contemplate these and similar implementations or configurations of the present invention.

As noted above, the present invention addresses the scenario in which multimedia session continuity is maintained while the session migrates from one device to another. Such a session is most likely, but not necessarily, started from a mobile device and streamed from a server over a network. Such seamless session handover is particularly appealing in a pervasive/ubiquitous computing environment in which mobile users take advantage of devices (wireless or fixed) around them anywhere, any time for the best user experience. Given their intended purposes, mobile handheld devices are generally small in display size, low on processing capacity and limited in battery power. These limitations sometimes restrict the user experience, especially for streaming multimedia applications. To address these limitations, these handheld devices can take advantage of the fixed devices in their vicinity to seamlessly hand off streaming multimedia flow to these fixed devices for processing and display. As an example, consider the scenario where a mobile user with an EDA (Entertainment Digital Assistant) starts a network streaming video session on his/her EDA. When the user moves close to a computer device with a big display (in comparison to the EDA), the session is automatically handed over to the big display with a much higher quality. While the user moves around, the video session can follow the user to different devices and can finally return back to the EDA when the user moves away from the fixed display devices. This results in a better user experience that simply using small handheld devices in a mobile networking environment.

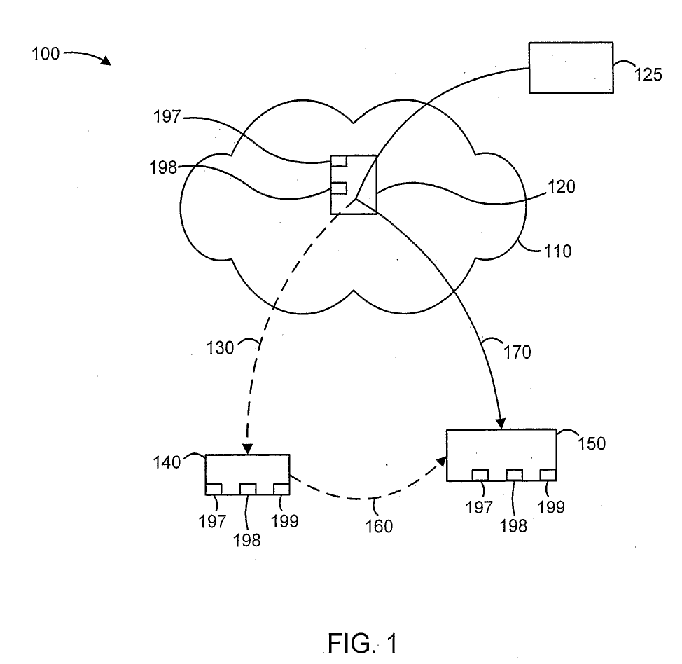

FIG. 1 is a diagram illustrating an environment 100 in which the present invention can be employed, according to an illustrative embodiment of the present invention. It is presumed that a user currently has a streaming multimedia session being conducted on a device (e.g. an EDA).

The environment 100 includes an access network 110 having a common router 120 and at least one multimedia server (hereinafter “multimedia server”) 125 therein. An original data flow path 130 is shown from the common router 120 to a first device (also referred to herein as “source device”) 140. A second device (also referred to herein as “target device”) 150 receives a session state transfer 160. Accordingly, a redirected flow path 170 is shown from the common router 120 to the target device 150.

The source device 140 and the target device 150 each include a transceiver 198 for transmitting and receiving media and other information. The source device 140 and the target device 150 each include a modem 197. Moreover, the source device 140 and the target device 150 each include a locating device 199 for locating other devices and for being located by other devices. It is to be appreciated that the router 120 also includes a transceiver 198 and a modem 197.

It is to be appreciated that the present invention is not limited to the preceding elements and, thus, other elements can also be employed in accordance with the present invention while maintaining the spirit of the present invention. Moreover, it is to be appreciated that the present invention is not limited to the preceding sub-elements (e.g., transceiver 198, modem 197, and so forth) and, thus, other sub-elements can also be employed in accordance with the present invention while maintaining the spirit of the present invention.

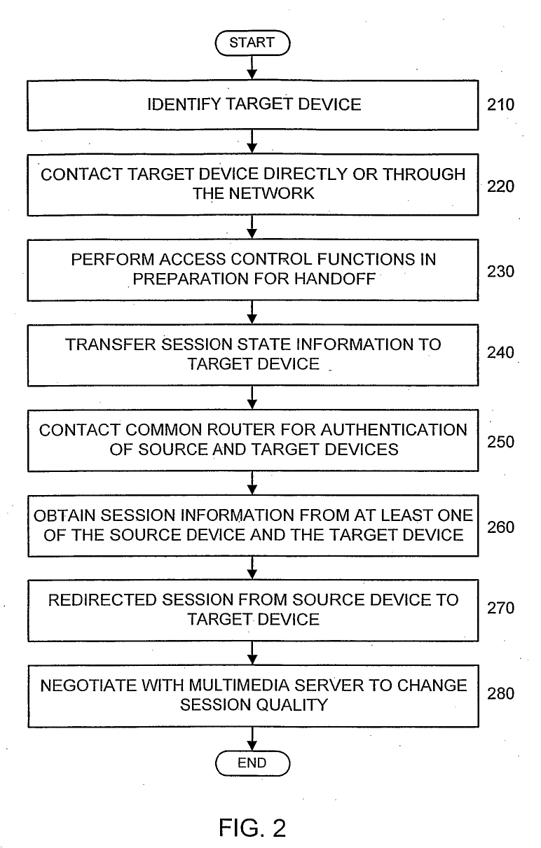

FIG. 2 is a flow diagram illustrating a method for handing off a media session from a first device to a second device in a network environment, according to an illustrative embodiment of the present invention.

The following method describes the steps in seamlessly moving a media session to a different device while maintaining session continuity.

As used herein, the phrase “source device” refers to a device on which a media session is currently being conducted/hosted, and the phrase “target device” refers to a device to which the current media session is to be handed-over to from the source device. Moreover, the source device receives the media for the media session from one or more multimedia servers (hereinafter “multimedia server”). The source and target devices can be mobile, fixed, or a combination thereof. For illustrative purposes, the source device described in the example of FIG. 2 is a mobile device.

A target device 150 is first identified (step 210). The identification can be either initiated by the access network 110 or by the source device 140 itself.

After the network 110 identifies the target device 150, the network can track the target device 150 using any known technique, apparatus, and/or system including, but not limited to, triangulation techniques, Global Positioning System (GPS), BLUETOOTH, and so forth. The triangulation techniques can be used to determine the target device location by gathering information form three wireless access points. The network 110 also maintains a list of fixed devices that can serve as target devices. The mobile user is notified of the existence of such devices once the network 110 determines that the user is close to one of the fixed devices.

In the case that the target device 150 is identified by the source device 140 itself, the source device 140 can be equipped with short range locating mechanisms including, but not limited to, a Bluetooth interface. Nearby devices equipped with Bluetooth interfaces can be automatically discovered when the source device moves into the vicinity.

The source device 140 contacts the target device 150 directly (e.g., through the Bluetooth interface) or through the network 110 regarding a handoff from the source device 140 to the target device 150 (step 220).

The target device 150 performs access control functions in preparation for the handoff from the source device 140 (step 230). The access control functions, include, but are not limited to, the following. The target device 150 can determine whether it currently has enough capacity to accommodate the session (e.g., the display is not completely occupied by other sessions). Further, the target device 150 can authenticate the user to make sure that the user has the right to use the target device 150 in the first place. Moreover, the target device 150 can determine whether the user has sufficient credits, if the user needs to pay for the service.

Session state information is transferred from the source device 140 to the target device 150, when the source device 140 passes access control (step 240). It is to be appreciated that the session state information is application dependent. One example of session state information can include, for example, the destination port number for the session so that the target device 150 can listen for the right session flow. Another example of session state information can include, for example, the multimedia server address and port number. Yet another example of session state information can include, for example, the starting frame sequence number of the session so that the target device 150 can resume the session from the right position. It is to be appreciated that the present invention is not limited to the preceding types of session state information and, thus, other types of session state information, as readily contemplated by one of ordinary skill in the related art given a specified application, can be employed in accordance with the present invention while maintaining the spirit of the present invention.

The source device 140 and the target device 150 each contact a common router (e.g., router 120) of the access network 110 to respectively authenticate themselves (step 250). The common router 120 is identified as the first crossover router when, for example, both devices send packets towards the multimedia server 125.

If both the source device 140 and the target device 150 are connected to the same sub network, then the router for the sub network is the common router. If the packets sent from both the source device 140 and the target device 150 do not cross over their paths in the access network 110 and the multimedia server 125 is located outside of the access network 110, then the gateway router to the Internet for the access network 110 is the common router.

If both the source device 140 and the target device 150 are not in the same network (e.g., the source device 140 is using a Third Generation (3G) cellular interface and the target device 150 is using a dial-up or cable Internet connection), or if the source device 140, the target device 150 and the multimedia server 125 are in the same sub network, then, in such cases, the router 120 would not be employed. Rather, the multimedia server 125 could, in such cases, perform the functions described herein with respect to the router 120. Given the preceding configuration examples of the source device 140, the target device 150, the multimedia server 125, and the router 120, other configurations involving these and related elements can be readily contemplated and implemented with respect to the present invention, while maintaining the spirit of the present invention.

The common router 120 obtains Session information from at least one of the source device 140 and the target device 150, once the common router 120 has authenticated both devices at step 250 (step 260). Based on the session information, the common router 120 sets up proper packet filtering and redirects the media session from the source device 140 to the target device 150 (step 270). For example, the common router 120 can set up packet filtering and perform redirection so that the destination IP address in the incoming packets (to the source device 140) for the session is rewritten to the IP address of the target device 150, and the source IP address in the outgoing packets (from the target device 150) for the session is rewritten to the IP address of the source device 140 (so that the multimedia server 125 is unaware that it is no longer communicating with the original device 140 and the session will not be disrupted).

The target device 150 can negotiate with the multimedia server 125 to upgrade/downgrade the quality of the session (step 280), once the session is properly migrated to the target device 150. For example, when the session is moved from a small mobile device to a big display device, the quality can be significantly upgraded.

Although the illustrative embodiments have been described herein with reference to the accompanying drawings, it is to be understood that the present invention is not limited to those precise embodiments, and that various other changes and modifications can be affected therein by one of ordinary skill in the related art without departing from the scope or spirit of the invention. All such changes and modifications are intended to be included within the scope of the invention as defined by the appended claims.

1. A method for handing off a media session from a source device to a target device in a network, comprising the steps of:
informing the target device of an impending handoff of the media session;
transmitting session state information to the target device in preparation for the handoff;
authenticating the source device prior to the handoff; and
ceasing to conduct the media session thereon in place of the target device, subsequent to the handoff.

2. The method of claim 1, further comprising the step of identifying the target device from among a plurality of possible target devices.

3. The method of claim 1, wherein said informing step comprises the step of the source device directly contacting the target device.

4. The method of claim 1, wherein said informing step comprises the step of the source device contacting the target device through the network.

5. The method of claim 1, wherein the session state information comprises at least one of a destination port number, a multimedia server address, and a starting frame sequence number.

6. The method of claim 1, wherein one of the source device and the target device is a mobile device and another one of the source device and the target device is a stationary device.

7. The method of claim 1, wherein one of the source device and the target device is a wireless device and another one of the source device and the target device is a wired device.

8. (canceled)

9. The method of claim 1, wherein packets sent from the source device and the target device have non-crossing paths in the network, the source device receives media for the media session from a multimedia server located outside the network, the network has a gateway router to the Internet, and the method further comprises the step of identifying the gateway router as a common router.

10. (canceled)

11. (canceled)

12. (canceled)

13. (canceled)

14. (canceled)

15. A method for handing off a media session from a source device to a target device in a network, comprising the steps of:
authenticating the source device and the target device with respect to an impending handoff from the source device to the target device, said source device and said target device being on a common sub-network having a router;
obtaining session related information from at least one of the source device and the target device; and
redirecting the session from the source device to the target device.

16. (canceled)

17. The method of claim 15, wherein the router is a gateway router to the Internet that corresponds to the network, when packets sent from the source device and the target device have non-crossing paths in the network, and the source device receives media for the media session from a multimedia server located outside the network.

18. A system for handing off a media session across multiple devices in a network, comprising:
a source device for initially receiving session media corresponding to the media session;
a target device for receiving session state information from the source device in preparation for a handoff of the media session; and
a common router for initially providing the session media to the source device, for authenticating the source device and the target device with respect to the handoff, for receiving session related information from at least one of the source device and the target device, and for redirecting the session media to the target device, and
wherein the target device conducts the media session in place of the source device, when the session media is redirected thereto.

19. The system of claim 18, wherein the source device comprises a locating device for locating the target device among a plurality of possible target devices.

20. The system of claim 18, wherein the target device comprises means for being discovered by the source device, when the target device is within a vicinity of the source device.

21. The system of claim 18, wherein one of the source device and the target device is a mobile device and another one of the source device and the target device is a stationary device.

22. A communications apparatus for handing off a media session from a source device to a target device in a network, comprising:
means for informing the target device of an impending handoff of the media session;
means for transmitting session state information to the target device in preparation for the handoff;
means for authenticating at least one of the source device and the target device prior to the handoff; and
means for ceasing the media session with the source device in place of the target device, subsequent to the handoff.

23. The communications apparatus according to claim 22 wherein the communications apparatus comprises a router.

24. A network for handing off a media session from a source device to a target device in a network, comprising:
means for informing the target device of an impending handoff of the media session;
means for transmitting session state information to the target device in preparation for the handoff;
means for authenticating at least one of the source device and the target device prior to handoff; and
means for ceasing to conduct the media session with the source device in place of the target device, subsequent to the handoff.
